(19) United States
(12) Patent Application Publication
(10) Pub. No.: US 2007/0118695 A1
(43) Pub. Date: May 24, 2007

(54) Decoupling storage controller cache read replacement from write retirement

(75) Inventors: Steven R. Lowe, Tucson, AZ (US); Dharmendra S. Modha, San Jose, CA (US); Binny S. Gill, Shrewsbury, MA (US); Joseph S. Hyde, Tucson, AZ (US)

Correspondence Address: LAW OFFICE OF DAN SHIFRIN, PC - IBM, 14081 WEST 59TH AVENUE, ARVADA, CO, 80004, US

(73) Assignee: International Business Machines Corporation, Armonk, NY (US)

(21) Appl. No.: 11/282,157

(22) Filed: Nov. 18, 2005

(51) Int. Cl. G06F 12/00; G06F 13/00

(52) U.S. Cl. 711/136

(57) ABSTRACT

In a data storage controller, accessed tracks are temporarily stored in a cache, with write data being stored in a first cache (such as a volatile cache) and a second cache and read data being stored in a second cache (such as a non-volatile cache). Corresponding least recently used (LRU) lists are maintained to hold entries identifying the tracks stored in the caches. When the list holding entries for the first cache (the A list) is full, the list is scanned to identify unmodified (read) data which can be discarded from the cache to make room for new data. Prior to or during the scan, modified (write) data entries are moved to the most recently used (MRU) end of the list, allowing the scans to proceed in an efficient manner and reducing the number of times the scan has to skip over modified entries Optionally, a status bit may be associated with each modified data entry. When the modified entry is moved to the MRU end of the A list without being requested to be read, its status bit is changed from an initial state (such as 0) to a second state (such as 1), indicating that it is a candidate to be discarded. If the status bit is already set to the second state (such as 1), then it is left unchanged. If a modified track is moved to the MRU end of the A list as a result of being requested to be read, the status bit of the corresponding A list entry is changed back to the first state, preventing the track from being discarded. Thus, write tracks are allowed to remain in the first cache only as long as necessary.

### TECHNICAL FIELD

The present invention relates generally to data storage controllers and, in particular, to establishing cache discard and destage policies.

### BACKGROUND ART

A data storage controller, such as an International Business Machines Enterprise Storage Server®, receives input/output (I/O) requests directed toward an attached storage system. The attached storage system may comprise one or more enclosures including numerous interconnected disk drives, such as a Direct Access Storage Device (DASD), Redundant Array of Independent Disks (RAID Array), Just A Bunch of Disks (JBOD), etc. If I/O read and write requests are received at a faster rate then they can be processed, then the storage controller will queue the I/O requests in a primary cache, which may comprise one or more gigabytes of volatile storage, such as random access memory (RAM), dynamic random access memory (DRAM), etc. A copy of certain modified (write) data may also by placed in a secondary, non-volatile storage (NVS) cache, such as a battery backed-up volatile memory, to provide additional protection of write data in the event of a failure at the storage controller. Typically, the secondary cache is smaller than the primary cache due to the cost of NVS memory.

In many current systems, an entry is included in a least recently used (LRU) list for each track that is stored in the primary cache. Commonly-assigned U.S. Pat. No. 6,785,771, entitled “Method, System, and Program for Destaging Data in Cache” and incorporated herein by reference, describes one such system. A track can be staged from the storage system to cache to return a read request. Additionally, write data for a track may be stored in the primary cache before being transferred to the attached storage system to preserve the data in the event that the transfer fails. Each entry in the LRU list entry comprises a control block that indicates the current status of a track, the location of the track in cache, and the location of the track in the storage system. A separate NVS. LRU list is maintained for tracks in the secondary NVS cache and is managed in the same fashion. In summary, the primary cache includes both read and modified (write) tracks while the secondary cache includes only modified (write) tracks. Thus, the primary LRU list (also known as the ‘A’ list) includes entries representing read and write tracks while the secondary LRU list (also known as the ‘N’ list) includes entries representing only write tracks. Although the primary and secondary LRU lists may each be divided into a list for sequential data (an “accelerated” list) and a list for random data (an “active” list), for purposes of this disclosure no such distinction will be made.

Referring to the prior art cache management sequences illustrated in FIGS. 1A-1F and FIGS. 2A and 2B, list entries marked with a prime symbol (′) represent modified track entries while those without the prime symbol represent unmodified or read entries. FIG. 1A illustrates examples of A and N lists which have already been partially populated with read and write entries. New entries are added to the most recently used (MRU) end of the LRU list to represent each track added to the primary cache. In FIG. 1B, a new write entry E′ has been added to the MRU end of both lists. As the new entries are added to the MRU ends, existing entries are “demoted” towards the LRU end of the lists. When a request is received to access a track, a search is made in the primary cache and, if an entry for the requested track is found (known as a “hit”), the entry is moved up to the MRU end of the list (FIG. 1C).

When additional space in the primary cache is needed to buffer additional requested read data and modified data, one or more tracks represented by entries at the LRU end of the LRU list are discarded from the cache and corresponding entries are removed from the primary LRU list (FIG. 1F in which entry A′ has been discarded from both caches when new entry H′ is added). A read data track in the primary cache may be discarded from the cache quickly because the data is already stored on a disk in the storage system and does not need to be destaged. However, a modified (write) data track in the primary and secondary caches may be discarded from the caches and lists only after it has been safely destaged to the storage system. Such a destage procedure may take as much as 100 times as long as discarding unmodified read data.

Due to the size difference between the primary and secondary caches, if a write data entry is discarded from the secondary (NVS) list after the associated track has been destaged from the secondary cache, it is possible that the entry and track remain in the primary LRU list and cache (FIGS. 2A and 2B in which write entry D′ is discarded from the secondary list while remaining in the primary list). In such an event, the status of the entry will be changed from “modified” to “unmodified” and remain available for a read request (FIG. 2B; entry D′ has been changed to D).

As noted above, if the primary cache does not have enough empty space to receive additional data tracks (as from FIG. 1D to 1E), existing tracks are discarded. In one currently used process, the primary LRU list is scanned from the LRU end for one or more unmodified (read) data entries whose corresponding tracks can be discarded quickly. During the scan, modified (write) data entries are skipped due to the longer time required to destage such tracks (FIG. 1E; unmodified entry C has been discarded). Even if the modified data entries are not skipped over but are destaged, they may not be able to free up space quickly enough for the new entries; and as long as the destage is in progress, these modified entries will have to be skipped over. As a result, during heavy write loads, some modified tracks may be modified several times and remain in the secondary cache for a relatively long time. Such tracks will also remain in the primary cache with the “modified” status before being destaged. Moreover, even after such tracks have eventually been destaged from the secondary cache, they may remain in the primary cache as “unmodified” and, if near the MRU end of the primary list, may receive another opportunity (or “life”) to move through the primary list. When there are many modified tracks in the primary cache, list scans have to skip over many entries and may not be able to identify enough unmodified tracks to discard to make room for new tracks. As will be appreciated, skipping over so many cached tracks takes a significant amount of time and wastes processor cycles. Because of these factors, the read replacement and write retirement policies are interdependent and write cache management is coupled to read cache management.

Thus, notwithstanding the use of LRU lists to manage cache destaging operations, there remains a need in the art for improved techniques for managing data in cache and performing the destage operation.

### SUMMARY OF THE INVENTION

The present invention provides system, method and program product for more efficient cache management discard/destage policies. Prior to or during the scan, modified (write) data entries are moved to the most recently used (MRU) end of the list, allowing the scan to proceed in an efficient manner and not have to skip over modified data entries. Optionally, a status bit may be associated with each modified data entry. When the entry is moved to the MRU end of the A list, its status bit is changed from an initial state (such as 0) to a second state (such as 1), indicating that it is a candidate to be discarded. If a write track requested to be accessed is found in the primary cache (a “hit”), the status bit of the corresponding A list entry is changed back to the first state, preventing the track from being discarded. Thus, write tracks are allowed to remain in the primary cache only as long as necessary.

### BRIEF DESCRIPTION OF THE DRAWINGS

FIGS. 1A-1F illustrate a prior art sequence of cache management;

FIGS. 2A and 2B illustrate another prior art sequence of cache management;

FIG. 3 is a block diagram of a data processing environment in which the present invention may be implemented;

FIG. 4 illustrates examples of LRU lists employed in the present invention;

FIGS. 5A and 5B illustrate a sequence of cache management according to one aspect of the present invention;

FIGS. 6A-6F illustrate a sequence of cache management according to another aspect of the present invention; and

FIGS. 7A-7E illustrate a sequence of cache management according to still another aspect of the present invention.

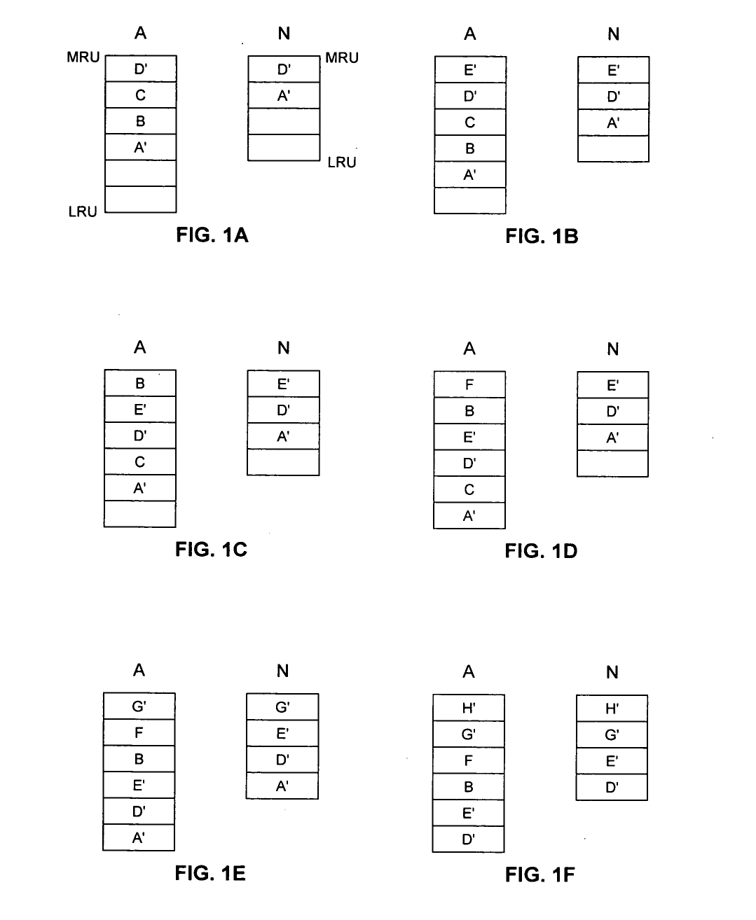

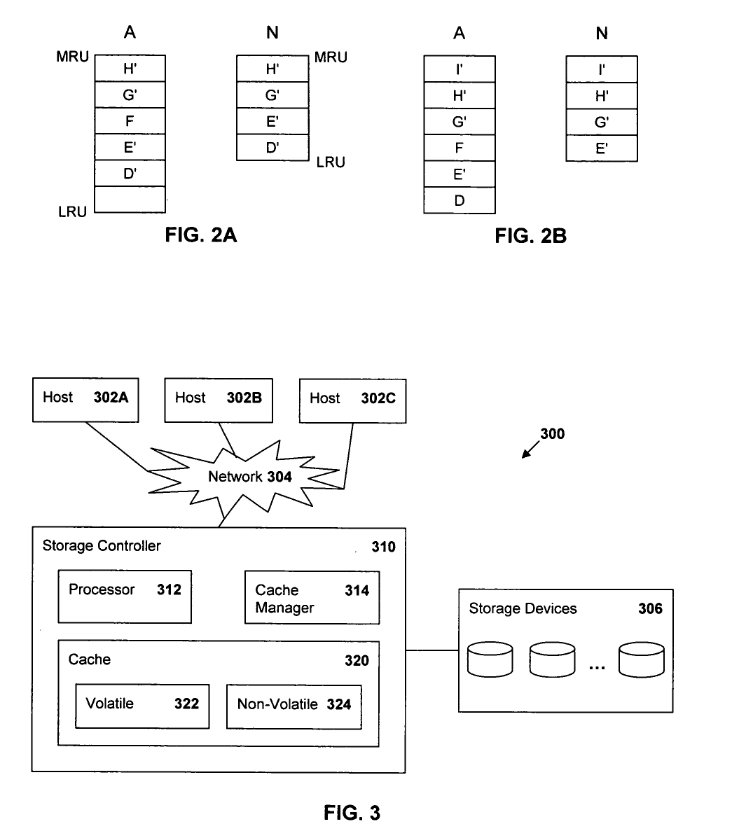

### DETAILED DESCRIPTION OF THE PREFERRED EMBODIMENT

FIG. 3 is a block diagram of a data processing environment 300 in which the present invention may be implemented. A storage controller 310 receives input/output (I/O) requests from one or more hosts 302A, 302B, 302C to which the storage controller 310 is attached through a network 304. The I/O requests are directed to tracks in a storage system 306 having disk drives in any of several configurations, such as a Direct Access Storage Device (DASD), a Redundant Array of Independent Disks (RAID Array), Just A Bunch of Disks (JBOD), etc. The storage controller 310 includes a processor 312, a cache manager 314 and a cache 320. The cache manager 314 may comprise either a hardware component or a software/firmware component executed by the processor 312 to manage the cache 320. The cache 320 comprises a first portion and a second portion. In one embodiment, the first cache portion is a volatile storage 322 and the second cache portion is non-volatile storage (NVS) 324. The cache manager 314 is configured to temporarily store read (unmodified) and write (modified) data tracks in the volatile storage portion 322 and to temporarily store only write (modified) data tracks in the non-volatile storage portion 324.

Although in the described implementations the data is managed as tracks in cache, in alternative embodiments the data may be managed in other data units, such as a logical block address (LBA), etc.

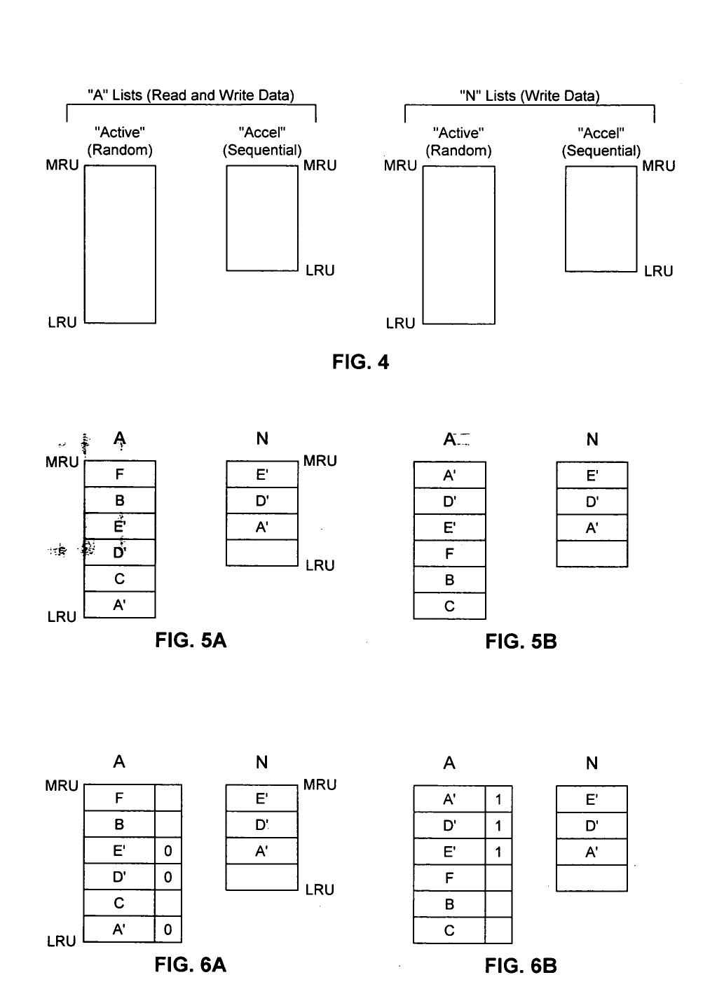

The cache manager 314 is further configured to establish a set of data track lists for the volatile cache portion 322 (the “A” lists) and a set of data track lists for the NVS cache portion 324 (the “N” lists). As illustrated in FIG. 4, one list in each set may be established to hold entries for random access data (the “Active” lists) and the second list to hold entries for sequential access data (the “Accel” lists). In the illustration, the Active lists are larger than the Accel lists; however, this need not be so. Moreover, the present invention is not dependent upon the presence of a division of track entries between Active and Accel lists and further description hereinafter will make no such distinction.

FIGS. 5A and 5B illustrate a sequence of cache management according to one aspect of the present invention. In FIG. 5A, the A list has been filled with read and write entries from the MRU end to the LRU end. Entries have also been entered into the N list from the MRU end to the LRU end, but the list is not yet full. Either some time before the addition of a new read or write entry into the A list, or as part of the process to add a new entry, the A list is rearranged by the cache manager 314 in preparation for the addition of the new entry. As summarized in the Background hereinabove, in a prior art process, the A list would be scanned from the LRU end up towards the MRU end to locate the first unmodified read entry. The track associated with that entry would then be discarded, making room in the volatile cache for the new entry. In contrast, however, in one variation of the present invention, the cache manager 314 moves all or enough of the modified (write) data entries to the MRU end of the A list, leaving one or more unmodified data entries at the LRU end (FIG. 5B). Then, when the cache manager 314 initiates a scan of the A list, no time or processor cycles are wasted trying to identify an unmodified data entry: such an entry is already at the LRU end and can immediately be discarded. In another variation, a scan of the A list is initiated and modified data entries are moved to the MRU end until an unmodified data entry is at the LRU end; the data track represented by that entry is then discarded.

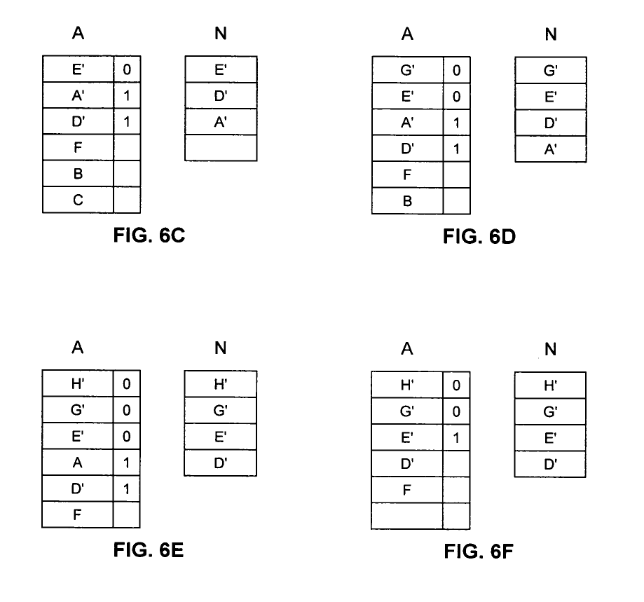

FIGS. 6A-6F illustrate a first optional enhancement to the embodiment described with respect to FIGS. 5A and 5B. Each write data entry includes an extra status bit which is initially set to 0 (FIG. 6A). For simplicity in implementing the present invention, all entries may include the status bit, initially set to 0. However, status bits associated with unmodified entries will remain at 0. In FIG. 6B, modified data entries (A′, D′ and E′) have been moved to the MRU end of the A list and their status bits have been changed to 1, indicating that they have progressed at least partially through the A list one time. As in the sequence of FIGS. 5A and 5B, all or some of the modified entries may be moved and they may be moved either prior to a scan or during a scan in which enough entries for modified data are moved to expose an entry for unmodified data at the LRU end.

Subsequently, a request is received by the storage controller 310 from a host 302 to access a modified track, such as track E′. Because the track is in the cache 320, it may be quickly read out of the cache instead of having to be retrieved from a storage device 306. The “hit” on track E′ causes the cache manager 314 to move the corresponding data entry to the MRU end of the A list and to change its status bit back to 0 (FIG. 6C), allowing the entry to move through the list again. Another write track added to the NVS cache 324 fills the cache 324 and its entry (G′) fills the N list. Its entry into the A list also forces the read entry at the LRU end of the A list (C) to be discarded (FIG. 6D). When still another write track is added to the NVS cache 324, the associated entry (H′) is added to the N list, forcing the write entry at the LRU end of the N list (A′) to be destaged to a storage device 306. The corresponding entry in the A list is changed from a modified to an unmodified state (FIG. 6E). Since its status bit is 1, the entry (A) is discarded from the A list (FIG. 6F), either immediately or during a subsequent scan.

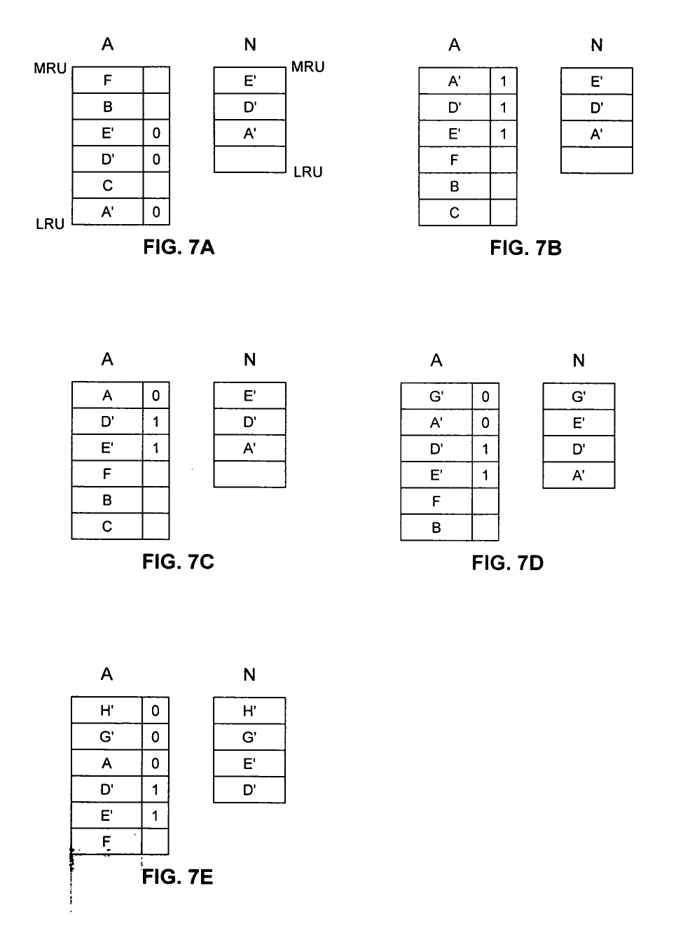

FIGS. 7A-7E illustrate an alternative procedure to that illustrated in FIGS. 6A-6E. The initial sequence (FIGS. 7A and 7B) is the same as that in the preceding procedure (FIGS. 6A and 6B). Next, a read hit on track A′ leaves the associated A list entry at the top of the MRU end of the A list (or moves it there if it was previously demoted towards the LRU end). Additionally, the entry's status bit is changed from 1 to 0 allowing the entry to move through the list again (FIG. 7C). A new write entry (G′) causes the N list to become full (FIG. 7D) while another new write entry (H′) forces A′ to be destaged from the N list. The cache manager 314 determines that the status bit of its corresponding A list entry is 0; therefore, the cache manager 314 changes the state from modified (A′) to unmodified (A), and does not discard the entry from the A list immediately. The entry (A) is given another opportunity to move through the A list and will be discarded only at a time when it is unmodified and has a status bit of 1.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies regardless of the particular type of signal bearing media actually used to carry out the distribution. Examples of computer readable media include recordable-type media such as a floppy disk, a hard disk drive, a RAM, and CD-ROMs and transmission-type media such as digital and analog communication links.

The description of the present invention has been presented for purposes of illustration and description, but is not intended to be exhaustive or limited to the invention in the form disclosed. Many modifications and variations will be apparent to those of ordinary skill in the art. For example, the foregoing describes specific operations occurring in a particular order. In alternative implementations, certain of the operations may be performed in a different order, modified or removed. Moreover, steps may be added to the above described operation and still conform to the described implementations. Further, operations described herein may occur sequentially or may be processed in parallel. The embodiments described were chosen and described in order to best explain the principles of the invention, the practical application, and to enable others of ordinary skill in the art to understand the invention for various embodiments with various modifications as are suited to the particular use contemplated. Moreover, although described above with respect to methods and systems, the need in the art may also be met with a computer program product containing instructions for managing cached data in a data storage controller.

What is claimed is:

1. A method for managing cached data in a data storage controller, comprising:
allocating memory spaces to a first cache in a data storage controller, the first cache having a most recently used (MRU) end and a least recently used end (LRU);
allocating memory spaces to a second cache in the data storage controller, the second cache having fewer memory spaces than the first cache and having a most recently used (MRU) end and a least recently used end (LRU);
temporarily storing read data entries in the first cache;
temporarily storing write data entries in the first and second caches;
receiving requests to access data entries in the first and second caches;
moving a data entry that is accessed and found in the first cache during a read from its current location in the first cache to the MRU end of the first cache;
moving a data entry that is accessed and found in the second cache during a write from its current location in the second cache to the MRU end of the second cache;
when a first read data entry is to be staged to the first cache:
if memory space is available in the first cache, moving all data entries then present in the first cache towards the LRU end of the first cache to accommodate the first read data entry;
if memory space is unavailable in the first cache:
moving at least one of the write data entries closest to the LRU end of the first cache from the then current locations in the first cache to the MRU end of the first cache while moving read data entries from the then current locations in the first cache to the LRU end of the first cache; and
discarding a read data entry from the LRU end of the first cache; and
staging the first read data entry into the MRU end of the first cache; and
when a first write data entry is to be staged to the first cache:
if memory space is available in both the first cache and the second cache, moving all data entries then present in the first and second caches towards the LRU ends of the first and second caches, respectively, to accommodate the first write data entry;
if memory space is unavailable in the first cache:
moving at least one of the write data entries closest to the LRU end of the first cache from the then current locations in the first cache to the MRU end of the first cache while moving read data entries from the then current locations in the first cache to the LRU end of the first cache; and
discarding a read data entry from the LRU end of the first cache; and
staging the first write data entry into the MRU end the second cache and into the MRU end of the first cache.

2. The method of claim 1, further comprising:
associating a status bit with each write data entry in the first cache, the status bit of each write data entry being set to a first state when each write data entry is staged to the first cache;
moving at least one write data entry from the then current location in the first cache to the MRU end of the first cache; and
setting the status bit of the at least one write data entry to a second state.

3. The method of claim 2, wherein moving comprises moving all write data entries from their then current locations in the first cache to the MRU end of the first cache.

4. The method of claim 2, wherein moving comprises moving at least one write data entry from the then current location in the first cache to the MRU end of the first cache until a read data entry is at the LRU end of the first cache.

5. The method of claim 2, further comprising:
receiving a read request to the second write data entry located in the first and second caches;
moving the hit second write data entry again from a current location in the first cache to the MRU end of the first cache;
setting the status bit of the second write data entry in the first cache to the first state;
attempting to temporarily store a third write data entry in the first and second caches;
if memory space is unavailable in the second cache:
destaging an existing write data entry from the LRU end of the second cache;
staging the third write data entry to MRU ends of the first cache and to the second cache;
demoting towards the LRU end the write data entry in the first cache which corresponds to the write entry destaged in the second cache; and
converting the demoted write data entry to a read data entry in the first cache.

6. The method of claim 5, further comprising removing the demoted write data entry from the first cache.

7. A data storage controller, comprising:
an interface through which data access requests are received from a host device;
an interface through which data is transmitted and received to and from at least one attached storage device;
a first cache comprising a first plurality of entry spaces for temporarily storing read and write data entries, the first plurality of entry spaces having a most recently used (MRU) end and a least recently used (LRU) end;
a second cache comprising a second plurality of entry spaces for temporarily storing write data entries, the second plurality of entry spaces being fewer than the first plurality of entry spaces, the second plurality of entry spaces having an MRU end and an LRU end; and
a cache manager programmed to:
receive requests to read or write data entries in the first and second caches;
move a data entry that is accessed and found in the first cache during a read request from its current location in the first cache to the MRU end of the first cache;
move a data entry that is accessed and found in the second cache during a write from a current location in the second cache to the MRU end of the second cache;
when a first read data entry is to be staged to the first cache:
if memory space is available in the first cache, move all data entries then present in the first cache towards the LRU end of the first cache to accommodate the first read data entry;
if memory space is unavailable in the first cache:
move one or more write data entries closest to the LRU end of the first cache from the then current locations in the first cache to the MRU end of the first cache and move read data entries from the then current locations in the first cache to the LRU end of the first cache; and
discard a read data entry from the LRU end of the first cache; and
stage the first read data entry into the MRU end of the first cache; and
when a first write data entry is to be staged to the first cache:
if memory space is available in both the first cache and the second cache, move all data entries then present in the first and second caches towards the LRU ends of the first and second caches, respectively, to accommodate the first write data entry;
if memory space is unavailable in the first cache:
move one or more write data entries closest to the LRU end of the first cache from the then current locations in the first cache to the MRU end of the first cache while moving read data entries from the then current locations in the first cache to the LRU end of the first cache; and
discard a read data entry from the LRU end of the first cache; and
stage the first write data entry into the MRU end the second cache and into the MRU end of the first cache.

8. The controller of claim 7, wherein:
the first cache comprises volatile memory; and
the second cache comprises non-volatile memory.

9. The controller of claim 7, wherein the cache manager is further programmed to:
associate a status bit with each write data entry in the first cache, the status bit of each write data entry being set to a first state when each write data entry is staged to the first cache;
move at least one write data entry from the then current location in the first cache to the MRU end of the first cache; and
set the status bit of the at least one write data entry to a second state.

10. The controller of claim 9, wherein the cache manager is programmed to move the at least one write data entry by moving all write data entries from their then current locations in the first cache to the MRU end of the first cache.

11. The controller of claim 9, wherein the cache manager is to move the at least one write data entry by moving comprises moving at least one write data entry from the then current location in the first cache to the MRU end of the first cache until a read data entry is at the LRU end of the first cache.

12. The controller of claim 9, wherein the cache manager is further programmed to:
receive a read request to the second write data entry located in the first and second caches;
move the hit second write data entry again from a current location in the first cache to the MRU end of the first cache;
set the status bit of the second write data entry in the first cache to the first state;
attempt to temporarily store a third write data entry in the first and second caches;
if memory space is unavailable in the second cache:
destage an existing write data entry from the LRU end of the second cache;
stage the third write data entry to MRU ends of the first cache and to the second cache;
demote towards the LRU end the write data entry in the first cache which corresponds to the write entry destaged in the second cache; and
convert the demoted write data entry to a read data entry in the first cache.

13. The controller of claim 12, wherein the cache manager is further programmed to remove the demoted write data entry from the first cache.

14. A computer program product of a computer readable medium usable with a programmable computer, the computer program product having computer-readable code embodied therein for managing cached data in a data storage controller, the computer-readable code comprising instructions for managing cached data in a data storage controller, comprising:
allocating memory spaces to a first cache in a data storage controller, the first cache having a most recently used (MRU) end and a least recently used end (LRU);
allocating memory spaces to a second cache in the data storage controller, the second cache having fewer memory spaces than the first cache and having a most recently used (MRU) end and a least recently used end (LRU);
temporarily storing read data entries in the first cache;
temporarily storing write data entries in the first and second caches;
receiving requests to access data entries in the first and second caches;
moving a data entry that is accessed and found in the first cache during a read from its current location in the first cache to the MRU end of the first cache;
moving a data entry that is accessed and found in the second cache during a write from its current location in the second cache to the MRU end of the second cache;
when a first read data entry is to be staged to the first cache:
if memory space is available in the first cache, moving all data entries then present in the first cache towards the LRU end of the first cache to accommodate the first read data entry;
if memory space is unavailable in the first cache:
moving at least one of the write data entries closest to the LRU end of the first cache from the then current locations in the first cache to the MRU end of the first cache while moving read data entries from the then current locations in the first cache to the LRU end of the first cache; and
discarding a read data entry from the LRU end of the first cache; and
staging the first read data entry into the MRU end of the first cache; and
when a first write data entry is to be staged to the first cache:
if memory space is available in both the first cache and the second cache, moving all data entries then present in the first and second caches towards the LRU ends of the first and second caches, respectively, to accommodate the first write data entry;
if memory space is unavailable in the first cache:
moving at least one of the write data entries closest to the LRU end of the first cache from the then current locations in the first cache to the MRU end of the first cache while moving read data entries from the then current locations in the first cache to the LRU end of the first cache; and
discarding a read data entry from the LRU end of the first cache; and
staging the first write data entry into the MRU end the second cache and into the MRU end of the first cache.

15. The computer program product of claim 14, wherein the instructions further comprise:
associating a status bit with each write data entry in the first cache, the status bit of each write data entry being set to a first state when each write data entry is staged to the first cache;
moving at least one write data entry from the then current location in the first cache to the MRU end of the first cache; and
setting the status bit of the at least one write data entry to a second state.

16. The computer program product of claim 14, wherein the instructions for moving comprise instructions for moving all write data entries from their then current locations in the first cache to the MRU end of the first cache.

17. The computer program product of claim 14, wherein the instructions for moving comprise instructions for moving at least one write data entry from the then current location in the first cache to the MRU end of the first cache until a read data entry is at the LRU end of the first cache.

18. The computer program product of claim 14, wherein the instructions further comprise:
receiving a request to access the second write data entry located in the first and second caches;
moving the hit second write data entry again from a current location in the first cache to the MRU end of the first cache;
setting the status bit of the second write data entry in the first cache to the first state;
attempting to temporarily store a third write data entry in the first and second caches;
if memory space is unavailable in the second cache:
destaging an existing write data entry from the LRU end of the second cache;
staging the third write data entry to MRU ends of the first cache and to the second cache;
demoting towards the LRU end the write data entry in the first cache which corresponds to the write entry destaged in the second cache; and
converting the demoted write data entry to a read data entry in the first cache.

19. The computer program product of claim 18, wherein the instructions further comprise removing the demoted write data entry from the first cache.
